(19) United States
(12) Patent Application Publication
(10) Pub. No.: US 2019/0063254 A1
(43) Pub. Date: Feb. 28, 2019

(54) TURBOCHARGER UTILIZING VARIABLE-CAMBER TURBINE GUIDE VANE SYSTEM

(71) Applicant: GM Global Technology Operations LLC, Detroit, MI (US)

(72) Inventor: Jordan B. SCHWARZ, Oxford, MI (US)

(21) Appl. No.: 15/692,413

(22) Filed: Aug. 31, 2017

(51) Int. Cl. F01D 17/16; F01D 9/04; F02C 6/12

(52) U.S. Cl. CPC F01D 17/165; F01D 9/041; F05D 2240/12; F02C 6/12; F05D 2220/40; F01D 9/045

(57) ABSTRACT

A turbocharger includes a compressor section having a compressor housing and a compressor wheel and a turbine section having a turbine housing and a turbine wheel drivingly connected to the compressor wheel. At least one of the compressor housing and the turbine housing includes a variable camber vane system including an inner ring of airfoils and an outer ring of airfoils with one of the inner and outer rings of airfoils being movable relative to the other.

### FIELD

The present disclosure relates to a turbocharger and more particularly to a turbocharger utilizing a variable-camber turbine guide vane system.

### BACKGROUND

This section provides background information related to the present disclosure which is not necessarily prior art.

In a turbocharger it is often desirable to control the flow of exhaust gas into the turbine to improve the efficiency or operational range of the turbocharger. Various configurations of variable nozzles have been employed to control the exhaust gas flow to the turbine. Multiple pivoting vanes annularly positioned around the turbine inlet and commonly controlled to alter the throat area of the passages between the vanes is an approach which has been successfully used in prior turbochargers. In conventional variable geometry turbochargers, the series of pivoting guide vanes govern the flow angle into the turbine. The turning angle of the flow can be changed by pivoting the vanes. Individual vanes are actuated via a series of levers and/or connecting rings. An example of a connecting assembly is shown in U.S. Pat. No. 6,736,595. Today's variable geometry turbochargers have a complex variable geometry mechanism resulting in a high per-unit cost and known deficiencies. Accordingly, it is desirable to provide a turbocharger utilizing a variable-camber turbine guide vane system with reduced mechanical complexity and improved durability.

### SUMMARY

This section provides a general summary of the disclosure, and is not a comprehensive disclosure of its full scope or all of its features.

The present disclosure provides a turbocharger includes a compressor section having a compressor housing and a compressor wheel and a turbine section having a turbine housing and a turbine wheel drivingly connected to the compressor wheel. At least one of the compressor housing and the turbine housing includes a variable camber vane system including an inner ring of airfoils and an outer ring of airfoils with one of the inner and outer rings of airfoils being movable relative to the other.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an engine assembly according to the present disclosure;

FIG. 2 is a cross-sectional view of a turbocharger having a turbine section with a variable-camber vane ring system according to the principles of the present disclosure;

FIG. 3 is a perspective view of the turbine wheel and the variable-camber vane ring system according to the principles of the present disclosure;

FIG. 4 is a plan view of the variable-camber vane ring system in a first position according to the principles of the present disclosure;

FIG. 5 is a plan view of the variable-camber vane ring system in a second position according to the principles of the present disclosure;

FIG. 6 is a perspective view of an alternative variable-camber vane ring system in a first position according to the principles of the present disclosure; and

FIG. 7 is a plan view of the variable-camber vane ring system of FIG. 6 shown in a second position according to the principles of the present disclosure;

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

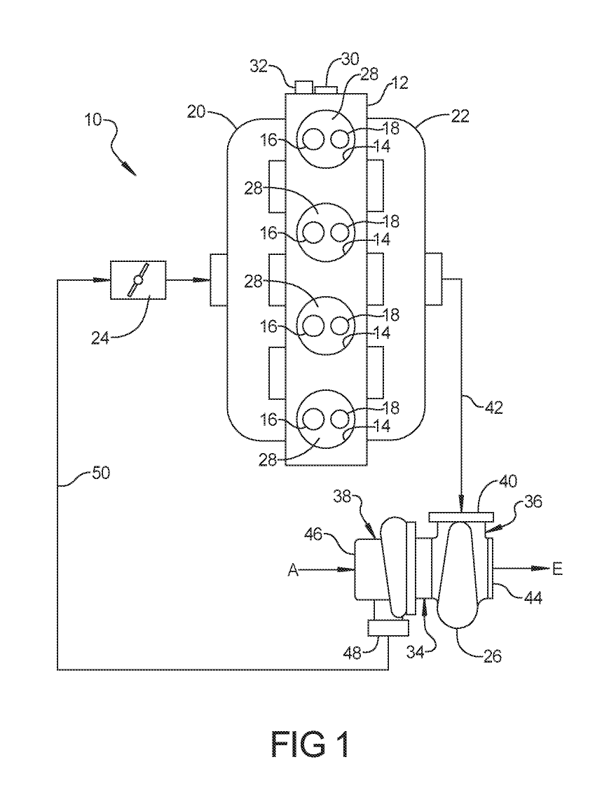

An engine assembly 10 is illustrated in FIG. 1 and may include an engine structure 12 defining cylinders 14 and intake and exhaust ports 16, 18 in communication with the cylinders 14, an intake manifold 20, exhaust manifold 22, a throttle valve 24 and a turbocharger 26. The engine assembly 10 is illustrated as an inline four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations. The engine assembly includes a piston 28 in each cylinder that are each drivingly connected to a crankshaft 30 as is well known in the art. An engine speed sensor 32 can be provided for detecting a rotational speed of the crankshaft or another component of the engine.

The turbocharger 26 includes a housing 34 defining a turbine section 36 and a compressor section 38. The turbine section 36 has an inlet 40 connected to the exhaust passage 42 and includes an exhaust outlet 44. The compressor section 38 includes an air inlet 46 and an air outlet 48 can provide compressed air to the air intake passage 50.

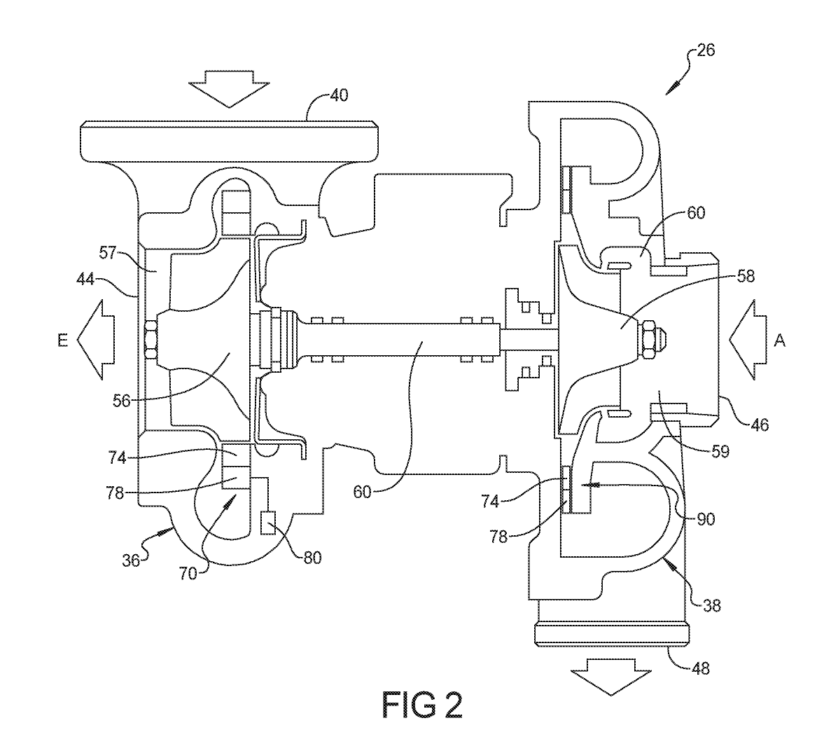

With reference to FIG. 2, the turbocharger 26 includes a turbine wheel 56 provided within a turbine chamber 57 of the turbine section 36 and a compressor wheel 58 within a compressor chamber 59 of the compressor section 38. The turbine wheel 56 and the compressor wheel 58 can be connected to one another by a shaft 60. Exhaust gases pass through the exhaust passage 42 and thus the turbine section 36 can drive the turbine wheel 56 which in turn drives the shaft 60 and compressor wheel 58. As the compressor wheel 58 is turned, the intake air from an air inlet 46 is compressed and delivered to the air outlet 48 so that the compressed air is delivered through the air intake passage 50 through the throttle valve 24 and intake manifold 20.

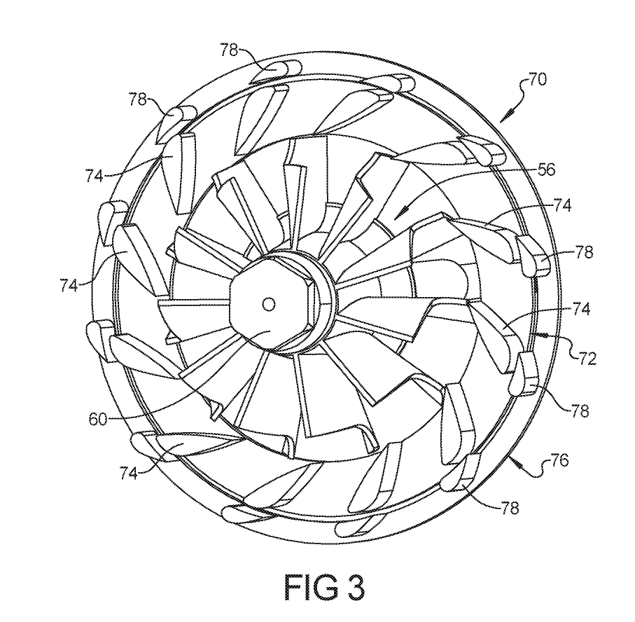

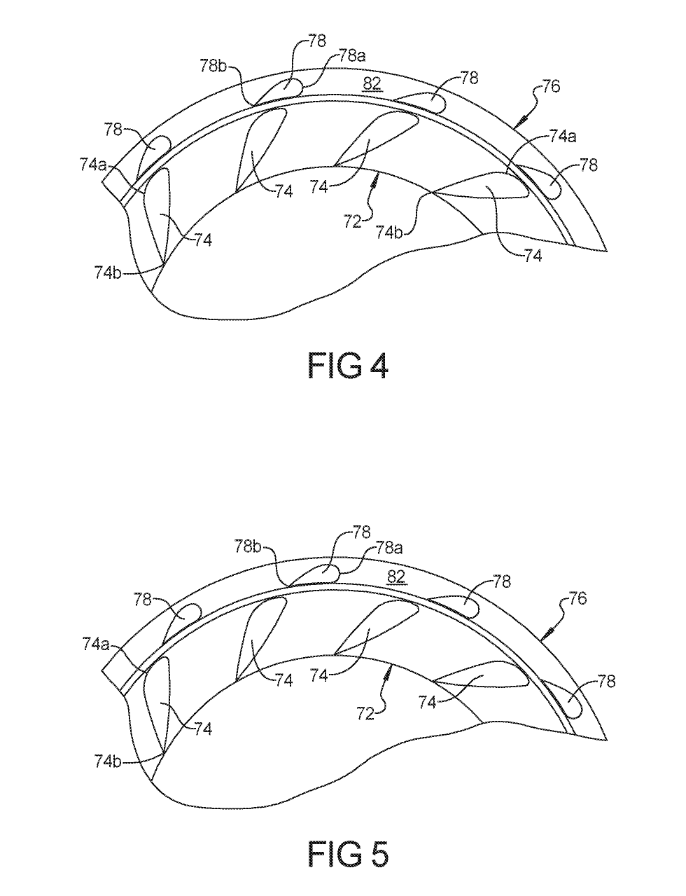

The turbine section 36 includes a variable-camber guide vane system 70. As best shown in FIGS. 3-5, the variable-camber guide vane system 70 can include an inner ring 72 of airfoils 74 and an outer ring 76 of airfoils 78. One of the inner ring 72 and the outer ring 76 of airfoils is circumferentially movable relative to the other of the inner ring 72 and the outer ring 76. The airfoils 74, 78 generally have a rounded widened forward end 74a, 78a and a pointed rearward edge 74b, 78b. In FIG. 4, the outer ring 76 of airfoils 78 are aligned with the inner ring 72 of airfoils 74 with a bottom edge of the forward end 78a of the outer airfoils 78 being generally aligned with a forward edge of the rounded widened forward end 74a of the airfoils 74 of the inner ring 72 and the pointed rearward edge 78b of the airfoils 78 are aligned with a rearward edge of the rounded widened forward end 74a of the airfoils 74 of the inner ring 72. In FIG. 5, the outer ring 76 is shown circumferentially rotated forward relative to the inner ring 72 so that the outer airfoils are disposed with the pointed rearward edge 78b of the airfoils 78 are aligned with a forward edge of the rounded widened forward end 74a of the airfoils 74 of the inner ring 72. Accordingly, in the position shown in FIG. 5, the effective airfoil shape of the combined airfoils 74 and 78 is modified as compared to the aligned airfoils 74 and 78 as shown in FIG. 4.

An actuator 80 is shown connected to the outer ring 76 of movable airfoils 78. The actuator 80 can be any known type and can be adjusted by a controller based upon the engine operating conditions. The airfoils 78 are mounted to an annular ring 82 and extend axially therefrom. Although the outer ring is shown as being movable in FIG. 2, it is recognized that the inner ring 72 can be movable relative to a fixed outer ring 76.

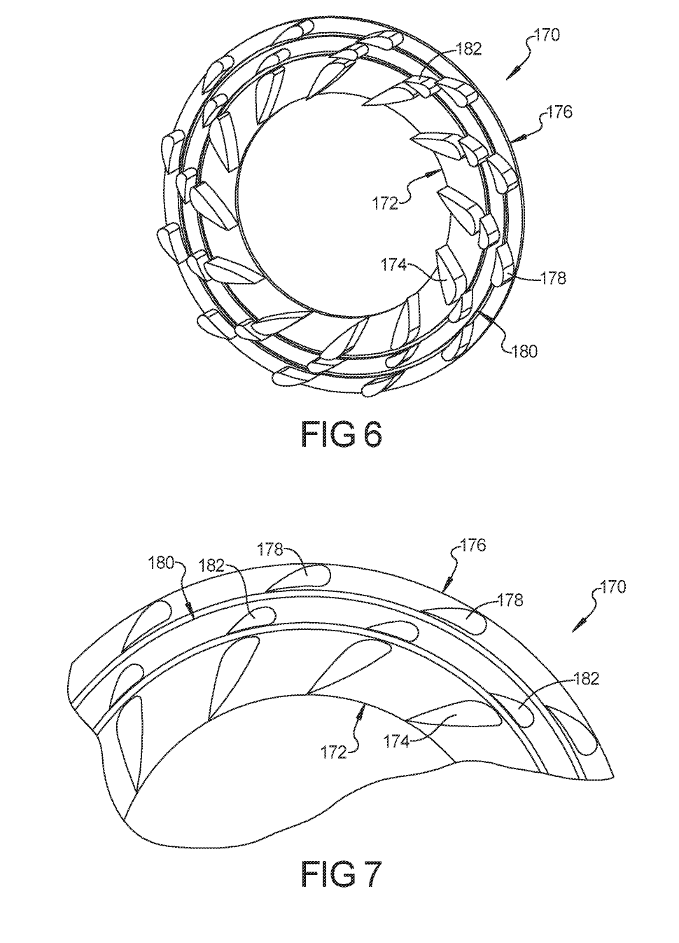

With reference to FIGS. 6 and 7, the variable-camber guide vane system 170 can include an inner ring 172 of airfoils 174 and an outer ring 176 of airfoils 178 and one or more intermediate rings 180 of airfoils 182. In the embodiment of FIGS. 6 and 7, two of the inner, outer and intermediate rings can be movable relative to the other of the inner, outer and intermediate rings to provide a the effective airfoils with a variable camber. In the embodiment of FIGS. 6 and 7, two separate actuators 80 can be utilized to alter a relative position of two of the rings relative to the other ring to produce a variable camber vane system.

As shown in FIG. 2, the variable-camber vane system can also be used in a diffuser 90 of the compressor section 38 of the turbocharger 26. In particular, the diffuser 90 can include a plurality of vanes that are configured by two or more rings 72, 76 of airfoils 74, 78 wherein one of the rings 72, 76 is movable relative to the other in order to provide a diffuser 90 with a variable camber vane system.

The variable-camber guide vane system of the present disclosure has reduced mechanical complexity, with only one movable component, as compared to prior systems. The reduced complexity results in lower cost and warranty claims. The variable-camber vane system, when employed in a diffuser of a compressor section, also provides improvements in operating range and efficiency for the compressor section.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A turbocharger, comprising:
a compressor section having a compressor wheel; and
a turbine section having a turbine housing and a turbine wheel drivingly connected to the compressor wheel, the turbine housing having a variable-camber vane ring system including an inner ring of airfoils and an outer ring of airfoils wherein one of the inner and outer rings of airfoils is circumferentially movable relative to the other of the inner and outer rings of airfoils.

2. The turbocharger according to claim 1, wherein the inner ring of airfoils include a first plurality of circumferentially spaced airfoils and the outer ring of airfoils include a second plurality of circumferentially spaced airfoils disposed on an annular ring that is rotatable relative to the inner ring of airfoils.

3. The turbocharger according to claim 1, wherein the outer ring of airfoils include a first plurality of circumferentially spaced airfoils disposed on a first annular ring and further comprising an intermediate ring of circumferentially spaced airfoils disposed on a second annular ring, said first and second annular rings being rotatable relative to the inner ring of fixed airfoils.

4. The turbocharger according to claim 1, wherein the outer ring of airfoils extend axially from an annular ring that is rotatable relative to the inner ring of fixed airfoils.

5. The turbocharger according to claim 1, wherein the inner and outer rings of airfoils each include a first plurality of circumferentially spaced airfoils and one of the inner and outer rings of airfoils includes an annular ring that is rotatable relative to the other of the inner and outer rings of airfoils.

6. The turbocharger according to claim 5, further comprising an actuator mechanism for moving the one of the inner and outer rings of airfoils relative to the other of the inner and outer rings of airfoils.

7. The turbocharger according to claim 1, further comprising an intermediate ring of airfoils disposed between the inner and outer rings of airfoils and wherein two of the inner, the outer and the intermediate rings of airfoils are circumferentially movable relative to the other of the inner, the outer and the intermediate rings of airfoils.

8. The turbocharger according to claim 7, further comprising an actuator mechanism for moving the two of the inner, the outer and the intermediate rings of airfoils relative to the other of the inner, the outer and the intermediate rings of airfoils.

9. A turbocharger, comprising:
a turbine section having a turbine wheel; and
a compressor section having a compressor housing and a compressor wheel drivingly connected to the turbine wheel, the compressor housing having a variable-camber vane ring system including an inner ring of airfoils and an outer ring of airfoils wherein one of the inner and outer rings of airfoils is circumferentially movable relative to the other of the inner and outer rings of airfoils.

10. The turbocharger according to claim 9, wherein the inner ring of airfoils include a first plurality of circumferentially spaced airfoils and the outer ring of airfoils include a second plurality of circumferentially spaced airfoils disposed on an annular ring that is rotatable relative to the inner ring of airfoils.

11. The turbocharger according to claim 9, wherein the outer ring of airfoils include a first plurality of circumferentially spaced airfoils disposed on a first annular ring and further comprising an intermediate ring of circumferentially spaced airfoils disposed on a second annular ring, said first and second annular rings being rotatable relative to the inner ring of fixed airfoils.

12. The turbocharger according to claim 9, wherein the outer ring of airfoils extend axially from an annular ring that is rotatable relative to the inner ring of fixed airfoils.

13. The turbocharger according to claim 9, wherein the inner and outer rings of airfoils each include a first plurality of circumferentially spaced airfoils and one of the inner and outer rings of airfoils includes an annular ring that is rotatable relative to the other of the inner and outer rings of airfoils.

14. The turbocharger according to claim 13, further comprising an actuator mechanism for moving the one of the inner and outer rings of airfoils relative to the other of the inner and outer rings of airfoils.

15. The turbocharger according to claim 9, further comprising an intermediate ring of airfoils disposed between the inner and outer rings of airfoils and wherein two of the inner, the outer and the intermediate rings of airfoils are circumferentially movable relative to the other of the inner, the outer and the intermediate rings of airfoils.

16. The turbocharger according to claim 15, further comprising an actuator mechanism for moving the two of the inner, the outer and the intermediate rings of airfoils relative to the other of the inner, the outer and the intermediate rings of airfoils.
